(19) United States
(12) Patent Application Publication
(10) Pub. No.: US 2013/0063669 A1
(43) Pub. Date: Mar. 14, 2013

(54) ILLUMINATION DEVICE, DISPLAY DEVICE, AND TELEVISION RECEPTION DEVICE

(71) Applicant: Hirokazu Mouri, Osaka-shi (JP)

(72) Inventor: Hirokazu Mouri, Osaka-shi (JP)

(21) Appl. No.: 13/697,867

(22) PCT Filed: Apr. 21, 2011
(86) PCT No.: PCT/JP2011/059786

§ 371 Date: Nov. 14, 2012

(30) Foreign Application Priority Data
Jun. 1, 2010 (JP) 2010-125449

(51) Int. Cl. F21V 7/05; H04N 5/66; G21K 5/02; F21V 13/04; G09F 13/04; F21V 9/10

(52) U.S. Cl. 348/739; 362/97.1; 362/235; 362/225; 362/231; 250/461.1; 348/E05.133

(57) ABSTRACT

In the disclosed direct-lighting illumination device and liquid crystal display device provided with said illumination device, in order to obtain an illumination device of which, image unevenness stemming from connector sections of the light-source-mounting substrates is decreased and the brightness on the display screen thereof is even, the illumination device (BL1, BL2, BL3, BL4) is configured with: a light-emitting surface section formed by assembling a plurality of light-source-mounting substrates (20) that are modularized and that are provided with input/output connectors (21) and a substrate (2) that mounts a plurality of point light sources (3); a reflective sheet (4) that has apertures that expose each point light source being laid over the light-emitting surface section; the connectors (21) being disposed only at the peripheral region of the light-emitting surface section; and the connectors (21) being covered by a reflective side wall (41).

### TECHNICAL FIELD

The present invention relates to an illumination device that irradiates a liquid crystal panel with light from behind the liquid crystal panel, a display device including the illumination device, and a television reception device, and relates particularly to an illumination device using an LED as a light source, a display device, and a television reception device.

### BACKGROUND ART

In recent years, there is coming into practical use an illumination device using an LED (light emitting diode) that, in addition to achieving improved light emission efficiency and an increased light emission amount, is long-life, reduced in power consumption, and environmentally friendly. Furthermore, since the development of a blue LED chip, there have been developed a white LED light source of a type that emits white light by using a blue LED chip in combination with a phosphor that, upon being excited by light from the LED chip, emits excitation light having a predetermined wavelength, and a white LED light source of another type that synthesizes white light by using three primary color LED chips, i.e. a blue LED chip, a green LED chip, and a red LED chip.

With this as a background, as a backlight for a liquid crystal display device or the like, there is used an illumination device in which white LED light sources of any of such types are arranged. Furthermore, as a backlight for a liquid crystal display device or the like, there are known a direct type backlight in which a light source is disposed behind a display screen and an edge light type backlight in which a light source is disposed at a side portion of a display screen and a light guide plate is installed behind the display screen and that is configured so that light enters the light guide plate from the side portion of the display screen and travels while being reflected through the light guide plate to be emitted in a planar shape from a light emission surface of the light guide plate.

Having the configuration in which a light source section is provided at the side portion of the display screen and the plate-shaped light guide plate is installed behind the display screen, the edge light type backlight can be easily reduced in thickness and thus is preferable from the viewpoint of thickness reduction of a liquid crystal display device and so on. Furthermore, the direct type backlight is preferable in that the light source is installed behind the display screen and directly illuminates the display screen, so that high-luminance illumination and area-by-area control of a light emission luminance are facilitated.

Furthermore, in such a direct type backlight using an LED, a plurality of LEDs are mounted on a common substrate so as to be modularized into a light source module (light source mounting substrate), and a plurality of the light source modules are installed to form a backlight that acts as a planar light emitting body having a large light emission area. In an illumination device (light source device) having a configuration including a plurality of light source modules, each pair of adjacent ones of the light source modules are jointed together for electrical connection, in which case it is desirable to prevent a joint section therebetween from impairing optical capabilities, and to this end, there has already been disclosed a light source device in which this connection is performed on a rear surface side opposite to a light emission surface (see, for example, Patent Document 1).

Also, there have already been disclosed a backlight device and a liquid crystal display device in which, even with a configuration in which an input connector and an output connector are provided on a light emission surface side, light loss is prevented by attaching a reflection sheet to a connector section where each of the connectors is provided (see, for example, Patent Document 2).

### LIST OF CITATIONS

### Patent Literature

Patent Document 1: JP-A-2008-181750
Patent Document 2: JP-A-2008-147147

### SUMMARY OF THE INVENTION

### Technical Problem

A direct type illumination device (LED backlight) that is adapted to a large screen size can be constructed by installing a plurality of light source modules (light source mounting substrates). Furthermore, when each pair of adjacent ones of the light source modules are connected together with a connector, a reflection sheet is attached to a connector section where the connector is provided, and thus light loss can be prevented to some extent.

The configuration in which the reflection sheet is attached to the connector section, however, is not preferable in that, due to work to attach the reflection sheet, a required number of man-hours is increased to lead to a cost increase. Furthermore, in a case of using an LED quipped with a wide directivity angle lens, light is blocked by a connector section located between light source mounting substrates joined together, i.e. between the wide directivity angle LEDs, leading to the occurrence of unevenness on a screen, which is not preferable.

Furthermore, the configuration in which, as in the light source device described in Patent Document 1, each pair of adjacent ones of the light source mounting substrates are connected together on the rear surface side is not preferable in that it presents a problem of workability in connection work being deteriorated and in that a component configuration becomes complex.

For the above-described reasons, in constructing an illumination device that is adapted to use in a display device having a large screen size, such as a television reception device, by installing a plurality of light source mounting substrates, it is desired that, using a simplest possible configuration, display unevenness attributable to a connector be reduced to provide a uniform luminance on a display screen.

In view of the above-described problems, it is an object of the present invention to provide an illumination device that, with regard to a direct type illumination device and a display device including the illumination device, in a case of installing a plurality of light source mounting substrates each mounting thereon a plurality of point light sources (LEDs), reduces screen unevenness attributable to a connector section of each of the light source mounting substrates and thus provides a uniform luminance on a display screen.

### Solution to the Problem

In order to achieve the above-described object, the present invention provides an illumination device including: a light source mounting substrate on which a plurality of point light sources are mounted and that is provided with an input/output connector; a reflection sheet that has an opening part for exposing each of the point light sources and covers a plurality of the light source mounting substrates; a light emission surface section that is composed of said mounting substrate and said reflection sheet; and a reflection side wall that intersects said light emission surface section. In the illumination device, the connector is disposed only in a peripheral region of the light emission surface section, and the connector is covered with the reflection side wall.

According to this configuration, in an inner region of the light emission surface section, i.e. an inner region of a display screen, the connector is not disposed, so that screen unevenness attributable to the connector is prevented from occurring in this inner region. Furthermore, the entire surface of the inner region of the light emission surface section is covered with the reflection sheet, with the point light sources being exposed, and the connector disposed in the peripheral region of the light emission surface section is covered with the reflection side wall, so that an illumination device can be obtained that reduces screen unevenness attributable to a connector section of the light source mounting substrate and thus can provide a uniform luminance on the display screen.

Furthermore, in the present invention, in the illumination device configured as above, the light emission surface section has a configuration in which a plurality of the light source mounting substrates are arrayed in parallel in two columns in a widthwise direction and from top to bottom in a lengthwise direction, and the connector and the reflection side wall are disposed in each of both end regions of the light emission surface section in the widthwise direction. According to this configuration, the long-sized light source mounting substrates each mounting thereon a plurality of the point light sources are arrayed in parallel in two columns in the widthwise direction, and thus an illumination device can be constructed that is adapted to a large screen size and prevents the occurrence of screen unevenness.

Furthermore, in the present invention, in the illumination device configured as above, the light emission surface section has a configuration in which a plurality of the light source mounting substrates are arrayed in parallel in two rows in a lengthwise direction and from side to side in a widthwise direction, and the connector and the reflection side wall are disposed in each of both end regions of the light emission surface section in the lengthwise direction. According to this configuration, the long-sized light source mounting substrates each mounting thereon a plurality of the point light sources are arrayed in parallel in two rows in the lengthwise direction, and thus an illumination device can be constructed that is adapted to a large screen size and prevents the occurrence of screen unevenness.

Furthermore, in the present invention, in the illumination device configured as above, the light emission surface section has a configuration including a left side region area in a left side region in a widthwise direction, in which a plurality of the light source mounting substrates are arrayed in parallel from top to bottom in a lengthwise direction, a right side region area in a right side region in the widthwise direction, in which a plurality of the light source mounting substrates are arrayed in parallel from top to bottom in the lengthwise direction, and a middle region area in a middle region between the left and right side region areas, in which a plurality of the light source mounting substrates are arrayed in parallel in a side-to-side direction, and the connector and the reflection side wall are disposed in each of respective end regions of these areas corresponding to a peripheral portion of the light emission surface section. According to this configuration, the plurality of the long-sized light source mounting substrates each mounting thereon a plurality of the point light sources are arrayed in parallel in each of both the left and right side regions in the widthwise direction and the middle region between the left and right side regions, and thus an illumination device can be constructed that is adapted to a large screen size and prevents the occurrence of screen unevenness.

Furthermore, in the present invention, in the illumination device configured as above, the light emission surface section has a configuration including a left side region area in a left side region in a widthwise direction, in which a plurality of the light source mounting substrates are arrayed in parallel from top to bottom in a lengthwise direction, a right side region area in a right side region in the widthwise direction, in which a plurality of the light source mounting substrates are arrayed in parallel from top to bottom in the lengthwise direction, and a middle upper side region area on an upper side and a middle lower side region area on a lower side in a middle region between the left and right side region areas, in each of which a plurality of the light source mounting substrates are arrayed in parallel in a side-to-side direction, and the connector and the reflection side wall are disposed in each of respective end portions of these areas corresponding to a peripheral portion of said light emission surface section. According to this configuration, the long-sized light source mounting substrates each mounting thereon a plurality of LEDs are arrayed in parallel in two columns on both the end sides in the widthwise direction, and in the middle region therebetween, the plurality of the light source mounting substrates are further provided on each of the upper and lower sides in the lengthwise direction, and thus an illumination device can be constructed that is adapted to a large screen size and prevents the occurrence of screen unevenness.

Furthermore, in the present invention, in the illumination device configured as above, the light source mounting substrate has a longitudinal shape, and a plurality of the point light sources are disposed in line on said substrate along a longitudinal direction thereof. According to this configuration, by combining the simply configured light source mounting substrates on each of which a plurality of the point light sources are disposed in line, an illumination device can be constructed that is adapted to a large screen size and prevents the occurrence of screen unevenness.

Furthermore, in the present invention, in the illumination device configured as above, the point light sources are disposed at an equal distance from each other on the light source mounting substrate. According to this configuration, by combining a plurality of the light source mounting substrates on each of which a plurality of the point light sources are disposed at an equal distance from each other, an illumination device can be constructed that provides a uniform color tone and a uniform luminance, is adapted to a large screen size, and prevents the occurrence of screen unevenness.

Furthermore, in the present invention, in the illumination device configured as above, the point light sources are each constituted of a light emitting diode. According to this configuration, by combining the light source mounting substrates each mounting thereon a plurality of light emitting diodes (LEDs), an LED illumination device (LED backlight) can be constructed that is adapted to a large screen size and prevents the occurrence of screen unevenness.

Furthermore, in the present invention, in the illumination device configured as above, the point light sources are each constituted of a light emitting diode obtained by applying a phosphor having a light emission peak in a yellow region to a blue light emitting chip to gain white light. According to this configuration, by combining the light source mounting substrates each mounting thereon a plurality of white light sources, an LED illumination device (LED backlight) can be constructed that is adapted to a large screen size and prevents the occurrence of screen unevenness.

Furthermore, in the present invention, in the illumination device configured as above, the point light sources are each constituted of a light emitting diode obtained by applying a phosphor having light emission peaks in green and red regions to a blue light emitting chip to gain white light. According to this configuration, by combining the light source mounting substrates each mounting thereon a plurality of white light sources, an LED illumination device (LED backlight) can be constructed that is adapted to a large screen size and prevents the occurrence of screen unevenness.

Furthermore, in the present invention, in the illumination device configured as above, the point light sources are each constituted of a light emitting diode obtained by applying a phosphor having a light emission peak in a green region to a blue light emitting chip and by combining the blue light emitting chip with a red light emitting chip to gain white light. According to this configuration, by combining the light source mounting substrates each mounting thereon a plurality of white light sources, an LED illumination device (LED backlight) can be constructed that is adapted to a large screen size and prevents the occurrence of screen unevenness.

Furthermore, in the present invention, in the illumination device configured as above, the point light sources are each constituted of a light emitting diode obtained by combining together blue, green, and red light emitting chips to gain white light. According to this configuration, by combining the light source mounting substrates each mounting thereon a plurality of white light sources, an LED illumination device (LED backlight) can be constructed that is adapted to a large screen size and prevents the occurrence of screen unevenness.

Furthermore, in the present invention, in the illumination device configured as above, the point light sources are each composed of an ultraviolet light emitting chip and a phosphor. According to this configuration, by combining the light source mounting substrates each mounting thereon a plurality of light sources that emit light of a predetermined color, an LED illumination device (LED backlight) can be constructed that is adapted to a large screen size and prevents the occurrence of screen unevenness.

Furthermore, in the present invention, in the illumination device configured as above, the point light sources are electrically connected together in series. According to this configuration, a plurality of the point light sources can be controlled to be turned on at equal timing, and thus improved reliability as an illumination device can be obtained.

Furthermore, in the present invention, in the illumination device configured as above, each of the point light sources has, on an outgoing surface thereof, a diffusion lens section for adjusting a light distribution of light outgoing from the each of the point light sources. According to this configuration, light outputted from each of the light sources is diffused over a predetermined area such that colors of light outputted by each pair of adjacent ones of the point light sources can be mixed and averaged, and thus an illumination device that provides a uniform color tone can be constructed.

Furthermore, in the present invention, in the illumination device configured as above, on the light source mounting substrate, a diffusion lens that can diffuse light from each of the point light sources is mounted so as to cover said each of the point light sources. According to this configuration, light outputted from each of the light sources is diffused over a predetermined area such that colors of light outputted by each pair of adjacent ones of the point light sources can be mixed and averaged, and thus an illumination device that provides a uniform color tone can be constructed.

Furthermore, in the present invention, in the illumination device configured as above, the reflection side wall is made of a resin having high reflectivity. According to this configuration, the reflection side wall that covers the connector section has high reflectivity, and thus an illumination device that prevents the occurrence of screen unevenness attributable to the connector can be constructed.

Furthermore, in the present invention, in the illumination device configured as above, the reflection side wall is constituted by an extended portion of the reflection sheet constituting the light emission surface section. According to this configuration, the reflection sheet is provided so as to extend up to the reflection side wall that covers the connector section, and thus a uniform reflectance is obtained across the entire region of the light emission surface section, so that an illumination device can be constructed that prevents the occurrence of screen unevenness attributable to the connector and thus provides a uniform luminance and a uniform color tone.

Furthermore, in the present invention, in the illumination device configured as above, the reflection sheet is fixed by riveting. According to this configuration, the reflection sheet is securely fixed, and thus a light emission surface section having a uniform surface can be constructed.

Furthermore, in the present invention, in the illumination device configured as above, the reflection sheet is fixed by being bonded onto the light source mounting substrate. According to this configuration, the reflection sheet is securely fixed onto the light source mounting substrate, and thus a large-sized light emission surface section made up of a plurality of the light source mounting substrates can be constructed.

Furthermore, the present invention further provides a display device including: the illumination device described in any one of claims 1 to 20; and a display panel that performs displaying by using light from said illumination device. This configuration allows illumination in such a manner that a uniform luminance and a uniform color tone are obtained across the entire surface of the display panel, and thus a display device having improved display quality can be obtained.

Furthermore, in the present invention, in the display device configured as above, the display panel is a liquid crystal panel using liquid crystal. According to this configuration, a liquid crystal display device having improved display quality can be obtained.

Furthermore, the present invention further provides a television reception device including the display device described in claim 21 or claim 22. According to this configuration, there can be obtained a television reception device that, even with a configuration in which a plurality of the light source mounting substrates at each of which the connector is provided are disposed, reduces screen unevenness attributable to the connector section to provide a uniform luminance on the display screen and thus has improved display quality.

### Advantageous Effects of the Invention

According to the present invention, a liquid crystal display device including a direct type illumination device has a configuration in which a plurality of light source mounting substrates are installed to form a light emission surface section; a connector is disposed only in an end region of said light emission surface section; and the connector disposed in this end region is covered with a reflection side wall. This allows reflection light to be uniformly emitted from the light emission surface section, so that an illumination device can be obtained that reduces screen unevenness attributable to a connector section of a light source mounting substrate and thus provides a uniform luminance on a display screen.

### BRIEF DESCRIPTION OF DRAWINGS

FIG. 1 A schematic plan view of an illumination device of a first embodiment according to the present invention.

FIG. 2 A schematic sectional view of a display device including the illumination device of the first embodiment.

FIG. 3 A schematic plan view of an illumination device of a second embodiment.

FIG. 4 A schematic plan view of an illumination device of a third embodiment.

FIG. 5 A schematic plan view of an illumination device of a fourth embodiment.

FIG. 6 A schematic plan view showing a configuration of a conventional backlight.

FIG. 7 A main portion enlarged sectional view of the backlight shown in FIG. 6.

### DESCRIPTION OF EMBODIMENTS

Hereinafter, embodiments of the present invention will be described with reference to the appended drawings. In the following, like constituent members are indicated by like reference symbols, and detailed descriptions thereof are omitted where appropriate.

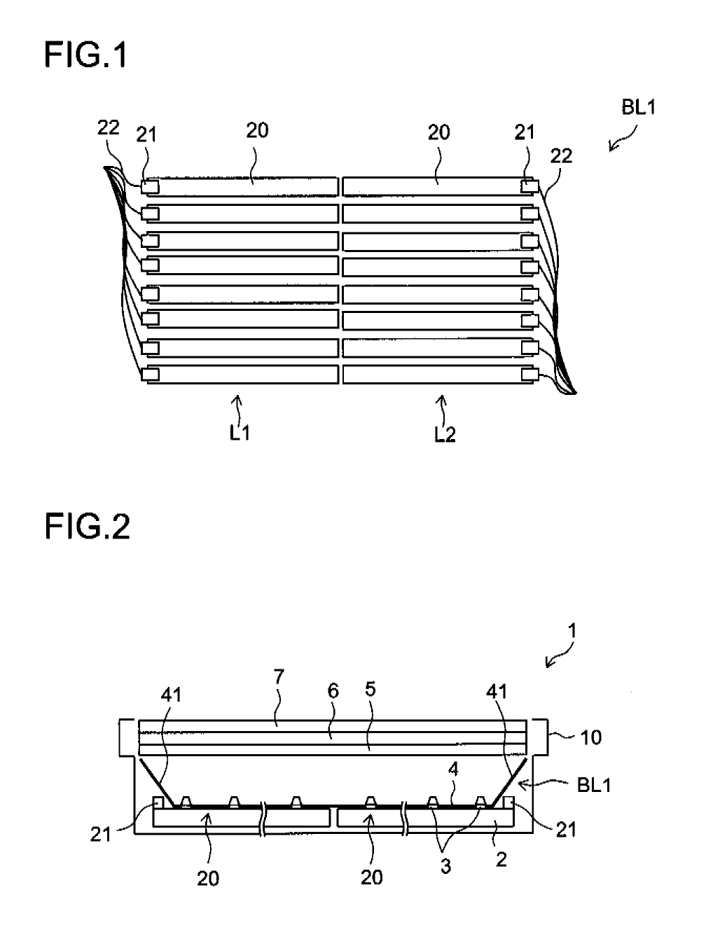

First, with reference to FIGS. 1 and 2, a description is given of one example of an illumination device according to the present invention.

FIG. 1 shows a schematic plan view of an illumination device BL1 of a first embodiment, and FIG. 2 shows a schematic structural view of a display device 1 including the illumination device BL1. In the illumination device BL1, a plurality of point light sources 3 are mounted on a substrate 2, to which an input/output connector 21 and a harness 22 made up of wiring cables are attached, so as to be modularized into a module as a light source mounting substrate 20.

Furthermore, a plurality of the light source mounting substrates 20 each obtained by such modularization are installed to form a light emission surface section in which the point light sources 3 are disposed at a predetermined distance from each other. In this embodiment, the light emission surface section is configured such that, in a case of installing a plurality of the light source mounting substrates 20, the connector 21 is disposed only in a peripheral region of said light emission surface section.

For example, as shown in FIG. 1, a plurality of the light source mounting substrates 20 are arrayed in parallel in two columns in a widthwise direction and from top to bottom in a lengthwise direction, and the connector 21 is disposed in each of both end regions in the widthwise direction. Furthermore, a reflection sheet 4 that has, at a part thereof corresponding to an upper portion of each of the point light sources, an opening for exposing each of the point light sources 3 is provided, and a connector 21 section where the connector 21 is disposed is covered with a reflection side wall 41 (see FIG. 2).

With the above-described configuration, in an inner region of the light emission surface section, i.e. an inner region of a display screen, the connector 21 is not disposed, so that screen unevenness attributable to the connector 21 is prevented from occurring in this inner region. Furthermore, the entire surface of the inner region of the light emission surface section is covered with the reflection sheet 4, with the point light sources 3 being exposed, and the connector 21 disposed in the peripheral region of the light emission surface section is covered with the reflection side wall 41, so that the illumination device BL1 can be obtained that reduces screen unevenness attributable to the connector section of each of the light source mounting substrates 20 and thus can provide a uniform luminance on the display screen.

In this case, preferably, the reflection side wall 41 is made of, for example, a resin having high reflectivity. With this configuration, the reflection side wall 41 that covers the connector section has high reflectivity, and thus an illumination device that prevents the occurrence of screen unevenness attributable to a connector can be constructed. Furthermore, the reflection side wall 41 may be constituted by an extended portion of the reflection sheet 4 constituting the light emission surface section. With this configuration, the reflection sheet 4 is provided so as to extend up to the reflection side wall 41 that covers the connector section, and thus a uniform reflectance is obtained across the entire region of the light emission surface section, so that an illumination device can be constructed that prevents the occurrence of screen unevenness attributable to a connector and thus provides a uniform luminance and a uniform color tone.

As described above, in the illumination device BL1 composed, as shown in FIG. 1, of a light source mounting substrate group L1 on the left side in the light emission surface section and a light source mounting substrate group L2 on the right side therein, the long-sized light source mounting substrates 20 each mounting thereon a plurality of the point light sources 3 are arrayed in parallel in two columns in the widthwise direction, and thus an illumination device can be constructed that is adapted to a large screen size and prevents the occurrence of screen unevenness.

The display device 1 including the illumination device BL1 described above is, for example, a liquid crystal display device having a configuration in which, as shown in FIG. 2, the illumination device BL1, a diffusion plate 5, a lens sheet 6, and a liquid crystal panel 7 are integrally assembled and mounted to a frame body 10.

Each of the diffusion plate 5 and the lens sheet 6 is a thin plate-shaped or film-shaped optical member for making incident light uniform by diffusing it and for obtaining an increased luminance and has a function of diffusing light emitted by the point light sources 3 so as to distribute the light across the entire region of the liquid crystal panel 7.

The liquid crystal panel 7 is a display panel having a configuration in which a liquid crystal material is sealed in a sandwiched manner between two transparent glass substrates, and on a laminate thus formed, a color filter and a polarization filter are laminated. In the liquid crystal panel 7, multiple lattice-patterned pixels are formed via switching elements formed in a lattice pattern, and a voltage applied to each of the switching elements is varied so as to cause liquid crystal orientation to vary to control the amount of light to be transmitted through the pixels, so that a predetermined image is displayed on an upper surface of the liquid crystal panel 7.

In the LED backlight BL1 in which a plurality of the light source mounting substrates 20 are installed to form a light emission surface section of a predetermined size, preferably, light emitted by each of the point light sources 3 is evenly applied, without being wasted, to the diffusion plate 5, and from this viewpoint, there could be provided, as the reflection sheet 4, a reflection sheet that reflects light toward the diffusion plate 5. To this end, in this embodiment, the reflection sheet 4 is laid over the entire surface of the light emission surface section. Furthermore, the reflection sheet 4 is configured to have the opening at the part thereof corresponding to the upper portion of each of the point light sources, and is laid over the entire surface of the light emission surface section, with the point light sources being exposed.

Furthermore, the reflection side wall 41 is provided in the peripheral region of the light emission surface section, in which the connector 21 is provided, and the reflection sheet 4 is provided so as to extend up to the reflection side wall 41. With this configuration, reflection from the peripheral region also can be achieved in an excellent manner. Since, as described above, the reflection sheet 4 is laid over the entire surface of the light emission surface section, with the point light sources being exposed, there can be obtained the illumination device BL1 that achieves uniform and even reflection toward the diffusion plate installed above the illumination device and thus can provide a uniform luminance on the display screen.

Preferably, the reflection sheet 4 is made of a material that exhibits a high reflectance with respect to light emitted by the point light sources 3, and, for example, in a case where white LED light sources are used as the point light sources 3, a reflection film that efficiently reflects visible light is used. Furthermore, a configuration also may be adopted in which a reflection member is laid that is a member made of a resin or the like to which a reflection film made of a polyester-based resin, which is used to efficiently reflect visible light (approximately, 400 to 800 nm), is attached.

Furthermore, in a case where the reflection sheet 4 is constituted of a bendable member, a configuration may be adopted in which the reflection sheet constituting the light emission surface section is bent at a rising position of the reflection side wall to form a side wall. As thus described, the reflection side wall 41 may be constituted by an extended portion of the reflection sheet 4 constituting the light emission surface section.

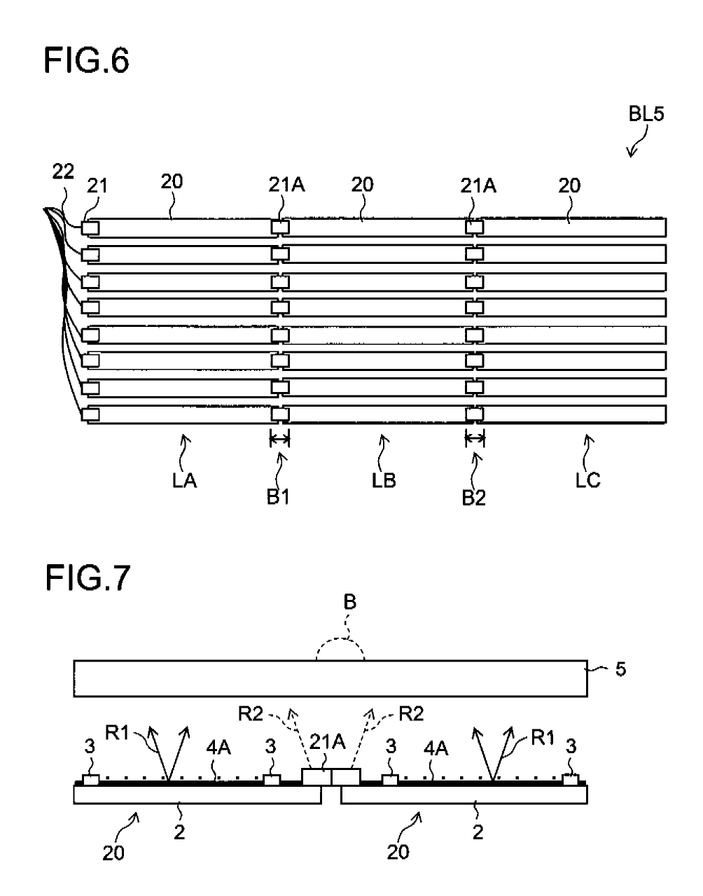

Herein, assuming, for example, a configuration in which, as shown in FIG. 6, each pair of adjacent ones of light source mounting substrates 20 are joined together via a connector 21A, in a case where a first light source mounting substrate group LA, a second light source mounting substrate group LB, and a third light source mounting substrate group LC are arrayed in parallel in three columns in a widthwise direction so that an illumination device BL5 that is adapted to use in a display device having a large-sized screen is obtained, a connector 21A section functioning as a joint section is positioned in an inner portion of a light emission surface section.

At the connector 21A section described above, a reflectance obtained is lower compared with that of a reflection sheet, so that there occurs a decrease in light emission luminance at this section, resulting in undesirably forming decreased luminance sections B1 and B2 where a luminance obtained is lower than that in the surroundings thereof. That is, in a case where the light source mounting substrate groups are installed in three columns, in addition to a connector 21 section in a peripheral portion, the decreased luminance sections B1 and B2 might be formed at two locations in the inner portion of the light emission surface section, respectively, which would appear in the form of two dark lines in a display screen.

This is based on the following reason. That is, in a case where, as shown in FIG. 7, each pair of adjacent ones of the light source mounting substrates 20, each of which is composed of a substrate 2 and multiple point light sources 3 mounted on the substrate 2, are joined together via the connector 21A, and a reflection sheet 4A having an opening for exposing each of the point light sources 3 and the connector 21A, which protrude from the substrate 2, is attached, reflection light R1 from the reflection sheet 4A has a high luminance, while reflection light R2 reflected from a surface of the connector 21A section provided so as to protrude from the substrate 2 has a low luminance.

Because of the above, in the illumination device BL5 having a conventional configuration, light entering a diffusion plate 5 disposed above the light emission surface section becomes uneven, so that a decreased luminance section B that is slightly darker than the surroundings thereof is formed on an upper surface of the diffusion plate 5, resulting in the occurrence of screen unevenness.

On the other hand, this embodiment adopts the configuration in which the connector is provided not in the inner region of the light emission surface section but only in the peripheral region of the light emission surface section, and the reflection sheet is laid over the entire surface of the light emission surface section including a connector section where the connector is provided, so that an illumination device can be obtained that reduces screen unevenness attributable to a connector section and thus provides a uniform luminance on a display screen.

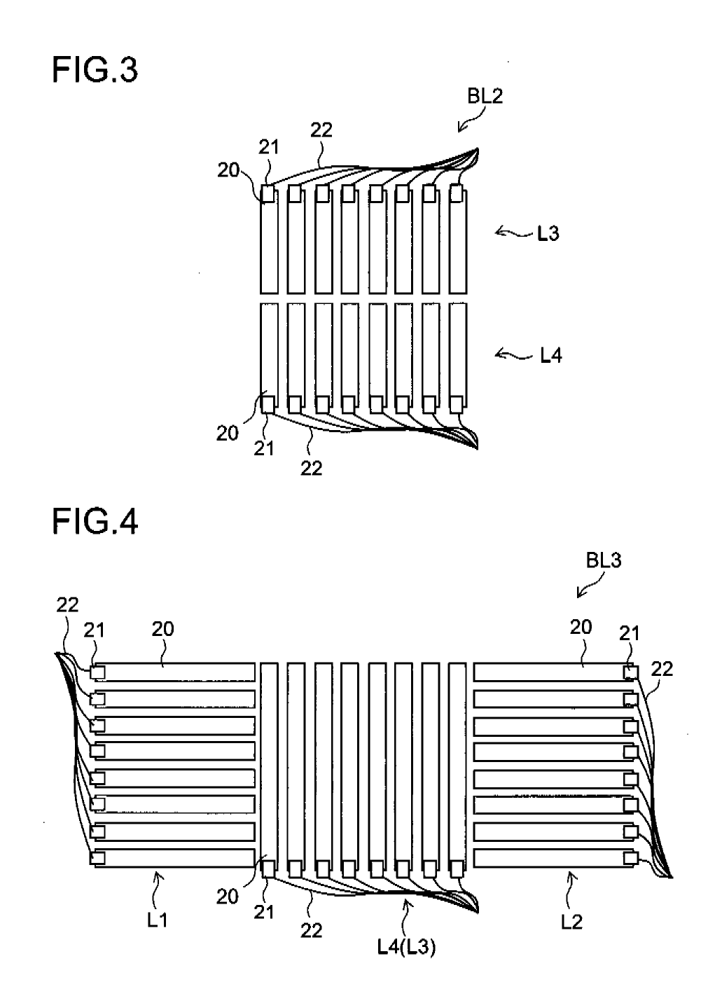

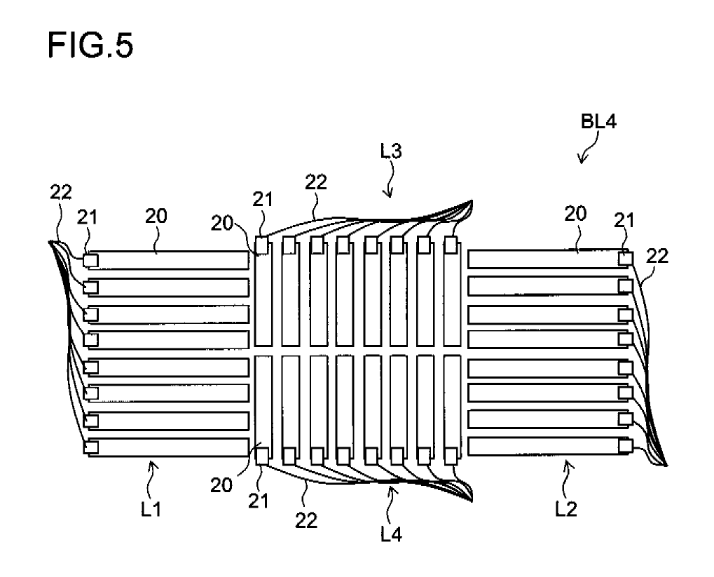

Furthermore, in addition to the illumination device BL1 of the first embodiment shown in FIG. 1, an illumination device BL2 of a second embodiment shown in FIG. 3, an illumination device BL3 of a third embodiment shown in FIG. 4, an illumination device BL4 of a fourth embodiment shown in FIG. 5, and so on can be constructed.

For example, in the illumination device BL2 of the second embodiment shown in FIG. 3, a light emission surface section thereof has a configuration in which a plurality of light source mounting substrates 20 are arrayed in parallel in two rows in a lengthwise direction and from side to side in a widthwise direction, and a connector 21 and the reflection side wall are disposed in each of both end regions of the light emission surface section in the lengthwise direction. With this configuration, the long-sized light source mounting substrates each mounting thereon a plurality of point light sources are arrayed in parallel in two rows in the lengthwise direction, so that an upper side region light source mounting substrate group L3 and a lower side region light source mounting substrate group L4 are provided, and thus an illumination device can be constructed that is adapted to a large screen size and prevents the occurrence of screen unevenness.

Furthermore, in the illumination device BL3 of the third embodiment shown in FIG. 4, a light emission surface section thereof has a configuration including a left side region area in a left side region in a widthwise direction, in which a plurality of light source mounting substrates 20 are arrayed in parallel from top to bottom in a lengthwise direction, a right side region area in a right side region in the widthwise direction, in which a plurality of light source mounting substrates 20 are arrayed in parallel from top to bottom in the lengthwise direction, and a middle region area in a middle region between the left and right side region areas, in which a plurality of light source mounting substrates 20 are arrayed in parallel in a side-to-side direction, and the connector and the reflection side wall are disposed in each of respective end regions of these areas corresponding to a peripheral portion of the light emission surface section. With this configuration, a plurality of the long-sized light source mounting substrates each mounting thereon a plurality of point light sources are arrayed in parallel in each of both the left and right side regions in the widthwise direction, while also being arrayed in parallel longitudinally in the middle region between the left and right side regions, so that in addition to a left side region light source mounting substrate group L1 and a right side region light source mounting substrate group L2, for example a lower side region mounting substrate group L4 with a connector 21 disposed on a lower side thereof is provided, and thus an illumination device can be constructed that is adapted to a large screen size and prevents the occurrence of screen unevenness. Furthermore, a configuration also may be adopted in which, in place of the lower side region mounting substrate group L4, an upper side region mounting substrate group L3 with the connector 21 disposed on an upper side thereof is used.

Furthermore, the illumination device BL4 of the fourth embodiment shown in FIG. 5 also can be used. The illumination device BL4 of the fourth embodiment has a configuration including a left side region area in a left side region in a widthwise direction, in which a plurality of light source mounting substrates 20 are arrayed in parallel from top to bottom in a lengthwise direction, a right side region area in a right side region in the widthwise direction, in which a plurality of light source mounting substrates 20 are arrayed in parallel from top to bottom in the lengthwise direction, and a middle upper side region area on an upper side and a middle lower side region area on a lower side in a middle region between the left and right side region areas, in each of which a plurality of light source mounting substrates 20 are arrayed in parallel in a side-to-side direction.

That is, an LED backlight BL4 has a configuration including, in addition to a left side region light source mounting substrate group L1 and a right side region light source mounting substrate group L2, a middle upper side region light source mounting substrate group L3 and a middle lower side region light source mounting substrate group L4. With this configuration, the long-sized light source mounting substrates 20 each mounting thereon a plurality of point light sources 3 are arrayed in parallel in two rows on both the end sides in the widthwise direction, and in the middle region therebetween, a plurality of the light source mounting substrates 20 are further provided on each of the upper and lower sides in the lengthwise direction, so that the LED backlight BL4 is made adaptable to a large screen size.

Furthermore, similarly to the illumination devices BL1, BL2, and BL3 of the aforementioned first to third embodiments, a connector 21 used for each of the light source mounting substrates 20 is provided in a peripheral region of a light emission surface section and not in an inner region of the light emission surface section. Furthermore, in this configuration, a reflection side wall 41 that covers the connector 21 is provided.

That is, the illumination device BL4 of the fourth embodiment has a configuration in which the connector 21 and the reflection side wall 41 are provided at each of both left and right end portions of the light emission surface section in the widthwise direction and at each of both upper and lower end portions thereof in the lengthwise direction. Furthermore, at each of the end portions in the widthwise direction and in the lengthwise direction, i.e. in the peripheral region of the light emission surface section, the connector 21 is installed, and the reflection side wall 41 that covers the connector is provided.

Thus, even in the illumination device BL4 that is large-sized to be adapted to a large-sized screen as described above, no connector is present in the inner region of the light emission surface section, and thus screen unevenness attributable to a connector section is reduced to be able to achieve uniform reflection in the light emission surface section. Consequently, an illumination device can be obtained that reduces screen unevenness attributable to a connector section where each pair of adjacent ones of light source mounting substrates are connected together and thus provides a uniform luminance on a display screen.

Furthermore, preferably, the light source mounting substrate 20 has a longitudinal shape, and a plurality of the point light sources 3 are disposed in line on said substrate along a longitudinal direction thereof. With this configuration, by combining the simply configured light source mounting substrates 20 on each of which a plurality of the point light sources 3 are disposed in line, an illumination device can be constructed that is adapted to a large screen size and prevents the occurrence of screen unevenness.

Furthermore, preferably, the point light sources 3 are disposed at an equal distance from each other on the light source mounting substrate 20. With this configuration, by combining a plurality of the light source mounting substrates 20 on each of which a plurality of the point light sources 3 are disposed at an equal distance from each other, an illumination device can be constructed that provides a uniform color tone and a uniform luminance, is adapted to a large screen size, and prevents the occurrence of screen unevenness.

Furthermore, preferably, the point light sources 3 are each constituted of a light emitting diode (LED). In a case where the point light sources 3 are LEDs 3, by combining the light source mounting substrates 20 each mounting thereon a plurality of the LEDs 3, an LED illumination device (LED backlight) can be constructed that is adapted to a large screen size and prevents the occurrence of screen unevenness.

In a case where the illumination devices BL1 to BL4 are LED backlights, preferably, the LEDs 3 that are point light sources are each constituted of a white LED light source that emits white light. As the white LED light source, for example, an LED can be used that is obtained by applying a phosphor having a light emission peak in a yellow region to a blue light emitting chip to gain white light. Furthermore, an LED obtained by applying a phosphor having light emission peaks in green and red regions to a blue light emitting chip to gain white light, an LED obtained by applying a phosphor having a light emission peak in a green region to a blue light emitting chip and by combining the blue light emitting chip with a red light emitting chip to gain white light, and an LED obtained by combining together blue, green, and red light emitting chips to gain white light also may be used. Moreover, an LED composed of an ultraviolet light emitting chip and a phosphor also may be used, and with any of these configurations adopted, by combining the light source mounting substrates 20 each mounting thereon a plurality of light sources that emit light of a predetermined color (for example, white), an LED illumination device (LED backlight) can be constructed that is adapted to a large screen size and prevents the occurrence of screen unevenness.

Furthermore, preferably, the LEDs 3 (point light sources) are electrically connected together in series. With this configuration, a plurality of the LEDs 3 (point light sources) can be controlled to be turned on at equal timing, and thus improved reliability as an illumination device can be obtained.

Furthermore, preferably, each of the LEDs 3 (point light sources) has, on an outgoing surface thereof, a diffusion lens section for adjusting a light distribution of light outgoing from the each of the point light sources. With this configuration, light outputted from each of the light sources is diffused over a predetermined area such that colors of light outputted by each pair of adjacent ones of the point light sources can be mixed and averaged, and thus an illumination device that provides a uniform color tone can be constructed.

As a method for forming the diffusion lens section on the outgoing surface, there can be adopted, for example, a method in which an outgoing surface of a sealing resin is solidified into a lens shape or a method in which a diffusion lens having a predetermined curvature is fitted to the outgoing surface. In a case of fitting such a lens thereto, on the light source mounting substrate 20, a diffusion lens that can diffuse light from each of the point light sources (LEDs 3) at a predetermined angle is mounted so as to cover said each of the point light sources. With this configuration in which a diffusion lens is fitted to the outgoing surface, by use of a lens that diffuses light outputted from each of the light sources over a desired area, colors of light outputted by each pair of adjacent ones of the point light sources can be mixed and averaged in an excellent manner, and thus an illumination device that provides a more uniform color tone can be constructed.

Furthermore, the reflection sheet 41 is fixed by, for example, riveting. With this configuration, the reflection sheet 41 is securely fixed, and thus a light emission surface section having a uniform surface can be constructed. Furthermore, a configuration also may be adopted in which the reflection sheet 41 is bonded onto the light source mounting substrate, and with this configuration, the reflection sheet 41 is securely fixed onto the light source mounting substrate by use of an adhesive, double-faced tape, or the like, and thus a large-sized light emission surface section made up of a plurality of light source mounting substrates can be constructed.

As described above, the embodiments of the present invention adopt the configuration in which the connector 21 provided at the light source mounting substrate 20 is disposed in the peripheral region of the light emission surface section, and the reflection side wall 41 is provided so as to cover the connector 21, thus preventing the occurrence of screen unevenness attributable to the connector 21.

Thus, a display device including an illumination device (LED backlight) having this configuration and a display panel that performs displaying by using light from the illumination device is made capable of illumination in such a manner that a uniform luminance and a uniform color tone are obtained across the entire surface of the display panel, and thus improved display quality of the display device can be obtained. Furthermore, in a case where the display panel is a liquid crystal panel using liquid crystal, a liquid crystal display device having improved display quality can be obtained.

A liquid crystal display device having a configuration including, as described above, any one of the illumination devices BL1 to BL4 according to the embodiments of the present invention and a liquid crystal panel is a liquid crystal display device preferable in that, by use of an LED backlight that, even with a plurality of light source mounting substrates disposed therein, reduces screen unevenness attributable to a connector section of each of the light source mounting substrates and thus provides a uniform luminance on a display screen, it provides a stable light emission luminance and thus prevents the occurrence of screen unevenness.

Thus, a television reception device including this liquid crystal display device allows the following. That is, there can be obtained a television reception device that, even with a configuration in which a plurality of light source mounting substrates at each of which a connector is provided are disposed, reduces screen unevenness attributable to a connector section where the connector is provided to provide a uniform luminance on a display screen and thus has improved display quality.

Furthermore, with a configuration in which the reflection sheet is provided so as to extend up to the reflection side wall provided in the peripheral region of the light emission surface section, in which the connector is provided, reflection light of a level equal to that of reflection light from a surrounding reflection surface is emitted also from this peripheral region, and thus there can be achieved uniform reflection from the entire surface of the light emission surface section.

The above-described configuration eliminates the need for work to attach the reflection sheet to the connector and work to provide a connection section on the back side of an LED substrate constituting the light source mounting substrate and to connect together each pair of adjacent ones of the substrates and thus can simplify work to install the light source mounting substrate and work to attach the reflection sheet.

The reflection side wall is in the form of a surface slanting so as to intersect the light emission surface section and so as to gradually become closer to a liquid crystal panel in a direction from the light emission surface section toward the peripheral portion, thus allowing a connector housing section to be provided below the reflection side wall. Thus, even with a configuration in which a plurality of the light source mounting substrates are installed, the connector is provided at the peripheral region of the light emission surface section and covered with the reflection side wall to which the reflection sheet is attached, so that the inner region of the light emission surface region and the peripheral region thereof are entirely covered with the reflection sheet, and thus a uniform light emission luminance is provided across the entire light emission surface.

As discussed in the foregoing, according to the present invention, in a direct type illumination device (LED backlight) and a liquid crystal display device including the illumination device, in a case of installing a plurality of light source mounting substrates to form a light emission surface section, a connector is disposed only in a peripheral region of said light emission surface section; the connector disposed in this end region is covered with a reflection side wall; and the entire region of the light emission surface section including a reflection side wall section where the reflection side wall is provided is covered with a reflection sheet. This can achieve uniform reflection from the light emission surface section, so that an illumination device (LED backlight) can be obtained that reduces screen unevenness attributable to a connector section of a light source mounting substrate and thus provides a uniform luminance on a display screen.

Furthermore, the reflection sheet has an opening at a part thereof corresponding to an upper portion of each of the LEDs and not at other parts thereof and thus is provided so as to extend up to the reflection side wall, with the LEDs being exposed, forming a reflection surface having an equal reflectance across the entire surface of the light emission surface section other than each LED light emission section, so that there can be provided a uniform luminance on the display screen.

Furthermore, the connector is covered with the reflection side wall in the form of a surface slanting toward the liquid crystal panel, so that the need for work to attach the reflection sheet to the connector is eliminated to facilitate work to attach the reflection sheet.

### INDUSTRIAL APPLICABILITY

The illumination device according to the present invention thus is favorably applicable to an illumination device (LED backlight) for a display device (liquid crystal display device), which is desired to reduce display unevenness on a screen to provide a stable light emission luminance so that improved image quality is provided.

### LIST OF REFERENCE SYMBOLS

1 display device (liquid crystal display device)
2 substrate
3 point light source (LED)
4 reflection sheet
41 reflection side wall
5 diffusion plate
7 liquid crystal panel (display panel)
10 frame body
20 light source mounting substrate
21 connector
22 harness
BL1 illumination device (first embodiment)
BL2 illumination device (second embodiment)
BL3 illumination device (third embodiment)
BL4 illumination device (fourth embodiment)
BL5 illumination device (conventional example)
B decreased luminance section

1. An illumination device, comprising:
a light source mounting substrate on which a plurality of point light sources are mounted and that is provided with an input/output connector;
a reflection sheet that has an opening part for exposing each of the point light sources and covers a plurality of the light source mounting substrates;
a light emission surface section that is composed of said mounting substrate and said reflection sheet; and
a reflection side wall that intersects said light emission surface section, wherein
the connector is disposed only in a peripheral region of the light emission surface section, and
the connector is covered with the reflection side wall.

2. The illumination device according to claim 1, wherein
the light emission surface section has a configuration in which a plurality of the light source mounting substrates are arrayed in parallel in two columns in a widthwise direction and from top to bottom in a lengthwise direction, and
the connector and the reflection side wall are disposed in each of both end regions of the light emission surface section in the widthwise direction.

3. The illumination device according to claim 1, wherein
the light emission surface section has a configuration in which a plurality of the light source mounting substrates are arrayed in parallel in two rows in a lengthwise direction and from side to side in a widthwise direction, and
the connector and the reflection side wall are disposed in each of both end regions of the light emission surface section in the lengthwise direction.

4. The illumination device according to claim 1, wherein
the light emission surface section has a configuration including a left side region area in a left side region in a widthwise direction, in which a plurality of the light source mounting substrates are arrayed in parallel from top to bottom in a lengthwise direction, a right side region area in a right side region in the widthwise direction, in which a plurality of the light source mounting substrates are arrayed in parallel from top to bottom in the lengthwise direction, and a middle region area in a middle region between the left and right side region areas, in which a plurality of the light source mounting substrates are arrayed in parallel in a side-to-side direction, and
the connector and the reflection side wall are disposed in each of respective end regions of these areas corresponding to a peripheral portion of the light emission surface section.

5. The illumination device according to claim 1, wherein
the light emission surface section has a configuration including a left side region area in a left side region in a widthwise direction, in which a plurality of the light source mounting substrates are arrayed in parallel from top to bottom in a lengthwise direction, a right side region area in a right side region in the widthwise direction, in which a plurality of the light source mounting substrates are arrayed in parallel from top to bottom in the lengthwise direction, and a middle upper side region area on an upper side and a middle lower side region area on a lower side in a middle region between the left and right side region areas, in each of which a plurality of the light source mounting substrates are arrayed in parallel in a side-to-side direction, and
the connector and the reflection side wall are disposed in each of respective end portions of these areas corresponding to a peripheral portion of said light emission surface section.

6. The illumination device according to claim 1, wherein
the light source mounting substrate has a longitudinal shape, and a plurality of the point light sources are disposed in line on said substrate along a longitudinal direction thereof.

7. The illumination device according to claim 1, wherein
the point light sources are disposed at an equal distance from each other on the light source mounting substrate.

8. The illumination device according to claim 1, wherein
the point light sources are each constituted of a light emitting diode.

9. The illumination device according to claim 1, wherein
the point light sources are each constituted of a light emitting diode obtained by applying a phosphor having a light emission peak in a yellow region to a blue light emitting chip to gain white light.

10. The illumination device according to claim 1, wherein
the point light sources are each constituted of a light emitting diode obtained by applying a phosphor having light emission peaks in green and red regions to a blue light emitting chip to gain white light.

11. The illumination device according to claim 1, wherein
the point light sources are each constituted of a light emitting diode obtained by applying a phosphor having a light emission peak in a green region to a blue light emitting chip and by combining the blue light emitting chip with a red light emitting chip to gain white light.

12. The illumination device according to claim 1, wherein
the point light sources are each constituted of a light emitting diode obtained by combining together blue, green, and red light emitting chips to gain white light.

13. The illumination device according to claim 1, wherein
the point light sources are each composed of an ultraviolet light emitting chip and a phosphor.

14. The illumination device according to claim 1, wherein
the point light sources are electrically connected together in series.

15. The illumination device according to claim 1, wherein
each of the point light sources has, on an outgoing surface thereof, a diffusion lens section for adjusting a light distribution of light outgoing from the each of the point light sources.

16. The illumination device according to claim 1, wherein
on the light source mounting substrate, a diffusion lens that can diffuse light from each of the point light sources is mounted so as to cover said each of the point light sources.

17. The illumination device according to claim 1, wherein
the reflection side wall is made of a resin having high reflectivity.

18. The illumination device according to claim 1, wherein
the reflection side wall is constituted by an extended portion of the reflection sheet constituting the light emission surface section.

19-20. (canceled)

21. A display device, comprising:
the illumination device according to claim 1; and
a display panel that performs displaying by using light from said illumination device.

22. (canceled)

23. A television reception device comprising the display device according to claim 21.
